(19) United States
(12) Patent Application Publication
(10) Pub. No.: US 2014/0033394 A1
(43) Pub. Date: Feb. 6, 2014

(54) MAGNETIC CLIP CORD MANAGEMENT SYSTEM

(71) Applicant: Joey Steven Stauffer, Lancaster, PA (US)

(72) Inventor: Joey Steven Stauffer, Lancaster, PA (US)

(21) Appl. No.: 13/567,001

(22) Filed: Aug. 3, 2012

(51) Int. Cl. A41D 27/00; A41D 1/00; A41D 27/20; H01F 7/02

(52) U.S. Cl. 2/69; 24/303; 24/3.12

(57) ABSTRACT

A magnetic clip provides a quick and easy method to attach an electronic device's cord to a user's clothing. The magnetic clip allows a user to create a fully customized cord management system, based upon their specific needs and/or preferences. The cord management system can include a tether to join a magnetic disk with a magnetic clip. The magnetic disk and magnetic clip can be disposed on opposite sides of a garment to position the magnetic clip securely on the user's garment, regardless of how slippery or form fitting the garment's material may be. A garment can have integrated magnetic disks, where the magnetic clip can attach.

### BACKGROUND OF THE INVENTION

The present invention relates to a cord management system and, more particularly, to a magnetic clip cord management system for quickly and easily attaching an electronic device's cord to a user's clothing.

Many electronic devices utilize a wire/cord to connect one component of the device to another. Depending on the device user's activity, this cord can be a nuisance by shifting, bouncing, tangling, and the like, often getting in the way of the user, and potentially becoming a dangerous distraction.

Currently available cord management systems do not provide an ideal solution to this problem. They tend to be cumbersome and limited in their use and/or application. Current cord management clip systems, for example, cannot be used in the middle of a garment very well, if at all. They also do not attach well to slippery or form fitting clothing. These conventional systems often rely on pincher clips and bundling the cord, which are both limited in their use and effectiveness.

As can be seen, there is a need for an improved cord management system.

### SUMMARY OF THE INVENTION

In one aspect of the present invention, a cord management system comprises a magnetic clip; a wire retainer disposed on a first side of the magnetic clip, the wire retainer operable to hold a wire therein; and a magnetic disk magnetically attracted to the magnetic clip.

In another aspect of the present invention, a cord management system comprises a magnetic clip; a wire retainer disposed on a first side of the magnetic clip, the wire retainer operable to hold a wire therein; a magnetic disk magnetically attracted to the magnetic clip; and a tether holding the magnetic clip on a first end thereof and holding the magnetic disk on a second, opposite end thereof, the tether being made of a flexible material.

These and other features, aspects and advantages of the present invention will become better understood with reference to the following drawings, description and claims.

### BRIEF DESCRIPTION OF THE DRAWINGS

FIG. 1 is a perspective view of a user using a cord management system according to an exemplary embodiment of the present invention;

FIG. 2 is a detailed perspective view of a cord management system according to an exemplary embodiment of the present invention;

FIG. 3 is a perspective view showing a garment having a plurality of integrated magnetic disk attachment points for a cord management system, according to another exemplary embodiment of the present invention;

FIG. 4 is a perspective view showing a garment having a plurality of pockets for storing magnetic disks, according to an exemplary embodiment of the present invention;

FIG. 5 is an exploded perspective view a clothes patch having an integrated magnetic disk, according to another exemplary embodiment of the present invention;

FIG. 6 is a perspective view showing an alternate use of the cord management system of the present invention;

FIG. 7 is a perspective view of a magnetic pendant necklace according to another exemplary embodiment of the present invention;

FIG. 8 is a perspective view of a magnetic clip integrated with a wireless electronic device according to an exemplary embodiment of the present invention;

FIG. 9 is a perspective view of a cord management system attached to a user at multiple locations, according to another exemplary embodiment of the present invention;

FIG. 10 is a perspective view of a cord management system, with a removable tether, according to an exemplary embodiment of the present invention; and

FIG. 11 is a perspective view of a cord management system, without a tether, according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a magnetic clip that provides a quick and easy method to attach an electronic device's cord to a user's clothing. The magnetic clip allows a user to create a fully customized cord management system, based upon their specific needs and/or preferences. The cord management system can include a tether to join a magnetic disk with a magnetic clip. The magnetic disk and magnetic clip can be disposed on opposite sides of a garment to position the magnetic clip securely on the user's garment, regardless of how slippery or form fitting the garment's material may be. A garment can have integrated magnetic disks, where the magnetic clip can attach.

As used herein, and in afore mentioned instances, the term “magnetic” refers to a material having the properties of a magnet or a material capable of being magnetized or attracted by a magnet.

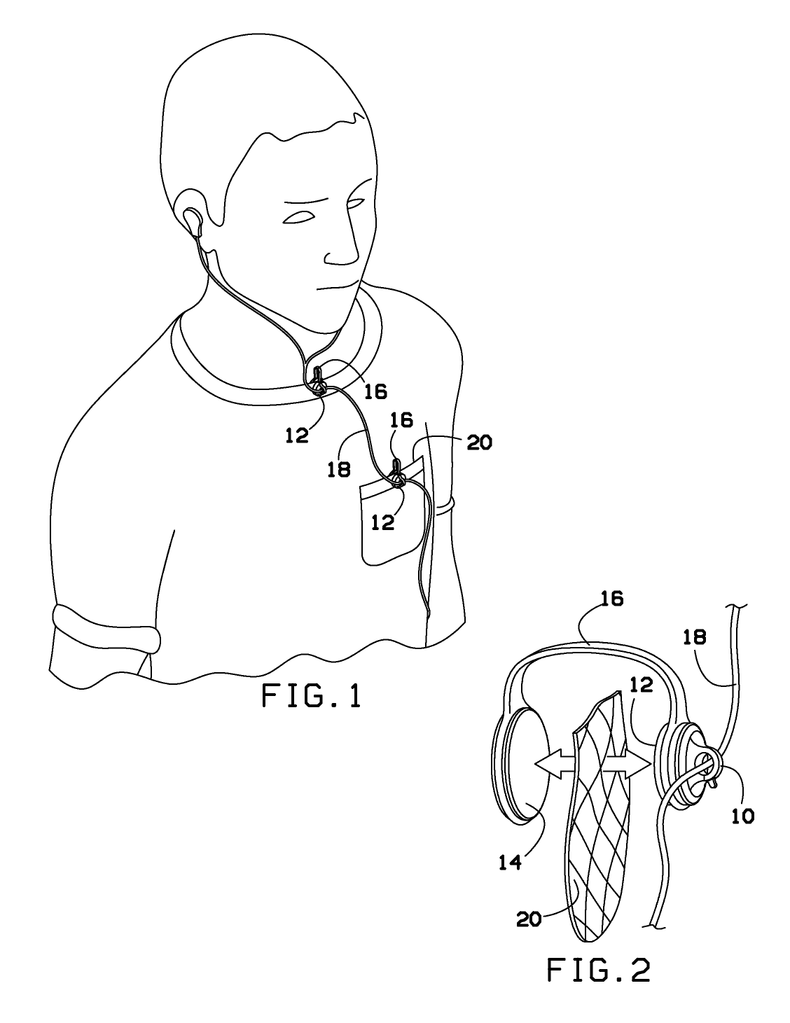

Referring to FIGS. 1 and 2, a cord management system can include a magnetic clip 12 having a wire retainer 10 and a magnetic disk 14. The magnetic clip 12 and the magnetic disk 14 can be magnetically attracted to each other and can, as shown in FIGS. 1 and 2, be disposed on opposite sides of a garment 20. In some embodiments, the magnetic clip 12 can include various types of magnetic materials as may be known in the art. The magnetic disk 14 can be a magnetically attractive metal, such as steel, or, in some embodiments, the magnetic disk 14 can be a magnet.

The wire retainer 10 can be formed in various sizes and shapes, depending on the specific application. The wire retainer 10 can include a mechanism allowing a user to open a closed loop to allow a wire 18 to be inserted thereinto. The wire retainer 10 can be made of various materials, such as metal, plastic, composite, or the like.

A tether 16 can be extended to connect the magnetic clip 12 to the magnetic disk 14. The tether 16 is typically made of a flexible material, such as rubber, plastic, or a similar polymeric material. The tether 16 can hold the magnetic clip 12 to the magnetic disk 14 to prevent loss and to help the magnetic clip 12 to stay in place.

The cord management system of FIGS. 1 and 2 can typically be placed on the garment 20 along an edge, such as at a neckline, a sleeve, or a pocket of the garment 20.

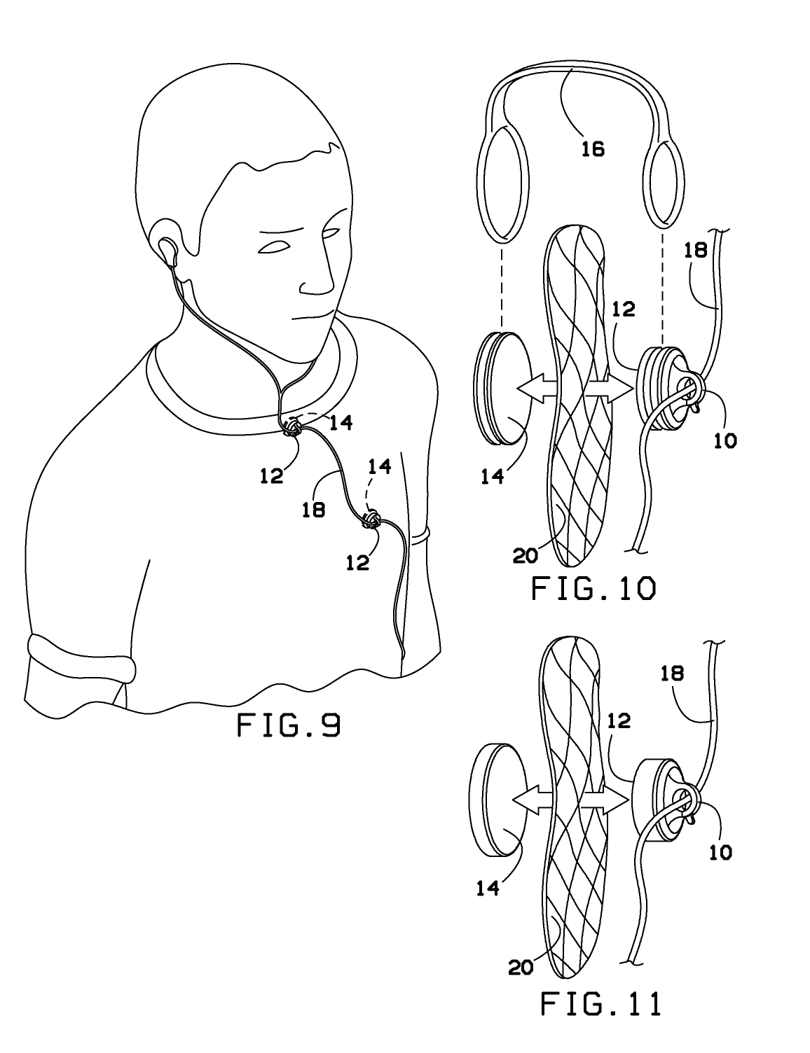

In some embodiments, the tether 16 can be removable from the magnetic clip 12 and the magnetic disk 14, as shown in FIG. 10. In this embodiment, as shown in FIGS. 9 and 11, the magnetic clip 12 and magnetic disk 14 can be placed on opposite sides of the garment 20 without needing to be placed adjacent to an edge thereof.

In some embodiments, the tether 16 can simply be not included with the cord management system, as shown in FIG. 11. In other embodiments, the tether 16 can be removable, as shown in FIG. 10. For example, the tether 16 may be made from a flexible, resilient material and the magnetic disk 14 and magnetic clip 12 can have channels into which loops of the tether 16 can wrap about. To remove the tether 16, the user can simply stretch the loops of the tether 16 to remove them from the channels formed about the magnetic clip 12 and the magnetic disk 14. In other embodiments, the tether 16 can be permanently attached to the magnetic disk 14 and magnetic clip 12.

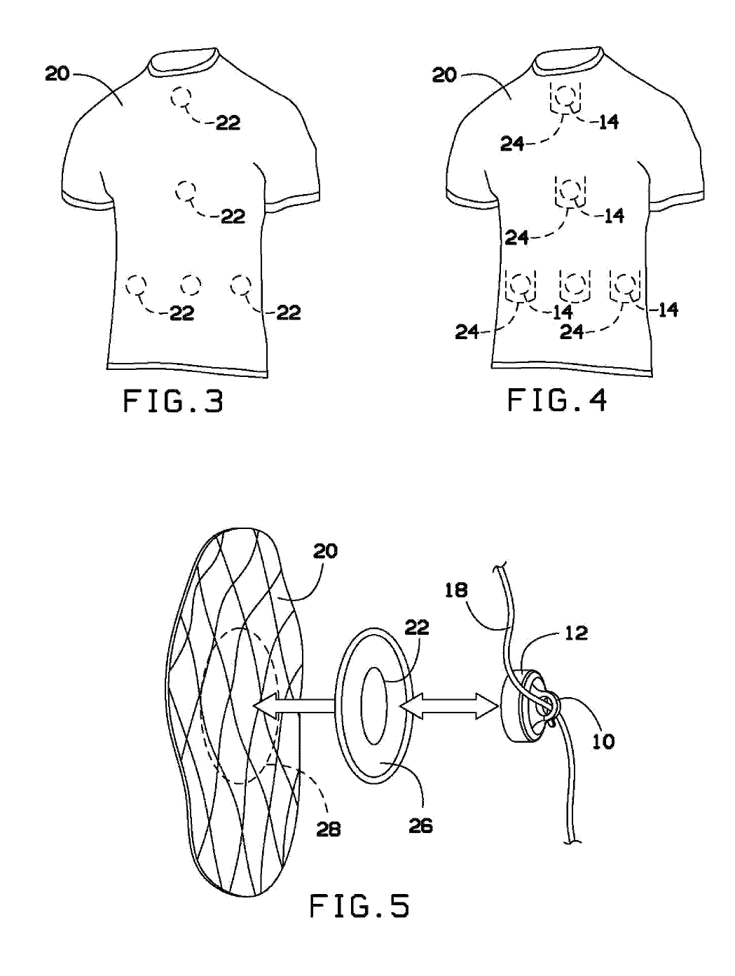

Referring now to FIGS. 3 through 5, the magnetic disk 14 can be made an integrated magnetic disk 22 and integrated into the garment 20. Various methods can be used to integrate the magnetic disk 22 into the garment 20. For example, the garment 20 can be designed with one or more integrated magnetic disks 22 already formed therewithin, as shown in FIG. 3. In other embodiments, the garment 20 can include one or more pockets 24 for disposing the magnetic disk 14 therein, as shown in FIG. 4. While FIGS. 3 and 4 show a plurality of locations for a integrated magnetic disk, the exact number of integrated disks, and locations of them, will depend on the intended user application.

In some embodiments, as shown in FIG. 5, the integrated magnetic disk 22 can be provided as a clothing patch 26 to be disposed on a patch location 28 of the garment 20. In this embodiment, a user can determine the best location or locations for the integrated magnetic disk 22 and apply the patch 26 themselves to the desired location(s). The clothing patch 26 can be design to attach in various manners to the garment 20, such as by stitching, heat application, adhesive or the like. The patch 26 can be designed to attach to either an inside or outside of the garment 20. The patch 26 can be of the same or different material or color as the garment 20 and may include advertisements, logos, or the like, printed, embossed or embroidered thereupon. When applied on the inside of the garment 20, the patch 26 can be the same or different material as the garment 20 and is typically made of a soft fabric with rounded edges to prevent irritation to the wearer.

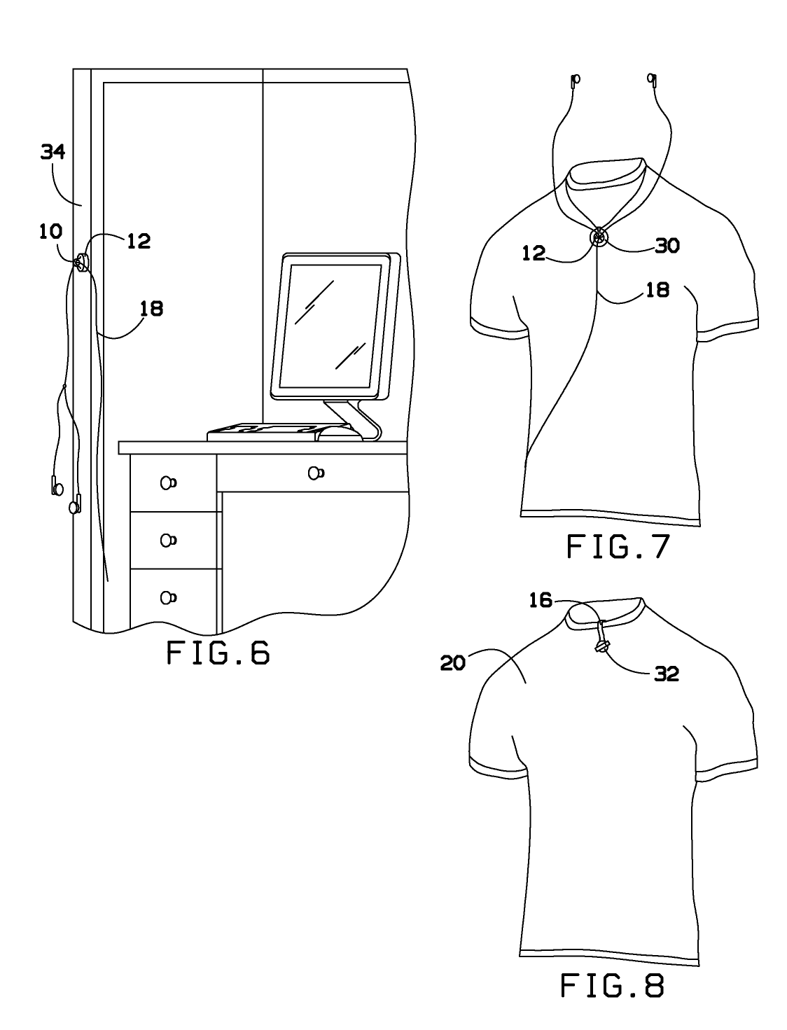

Referring to FIG. 6, the cord management system of the present invention may find utility outside of being a wearable system. For example, the magnetic clip 12 can be designed to attach to a magnetic surface 34 for storing the cord 18. This aspect of the present invention can help keep cords organized and out of the way when not in use.

Referring to FIG. 7, the magnetic clip 12 can be disposed as a magnetic pendant necklace 30. In this embodiment, the cord 18 can be fed through the wire retainer 10 on the magnetic clip 12 and the necklace 30 can be placed around the user's neck. In some embodiments, the necklace 30 can include the magnetic disk 14 as its pendant, where the magnetic clip 12 can attach to the magnetic disk 14 that is attached to the chain of the necklace 30. In other embodiments, the magnetic clip 12, itself, can be attached to the chain of the necklace 30 or some other wearable magnetic accessory.

Referring to FIG. 8, the system of the present invention could include a magnetic clip where the wire retainer is used to secure a wireless electronic device 32, such as a wireless microphone. In some embodiments, the wireless electronic device 32 can act as the magnetic clip, where the wireless electronic device 32 can include a magnet to be attracted directly to the magnetic disk. This would allow the user to place such an electronic device 32 on their garment 20 as opposed to conventional clips that often require a garment edge or requires bunching up and pinching the garment. In some embodiments, the wire retainer can be used to secure other items, such as a name tag, or the like.

It should be understood, of course, that the foregoing relates to exemplary embodiments of the invention and that modifications may be made without departing from the spirit and scope of the invention as set forth in the following claims.

What is claimed is:

1. A cord management system comprising:
a magnetic clip;
a wire retainer disposed on a first side of the magnetic clip, the wire retainer operable to hold a wire therein; and
a magnetic disk magnetically attracted to the magnetic clip.

2. The cord management system of claim 1, further comprising a tether interconnecting the magnetic clip with the magnetic disk.

3. The cord management system of claim 2, wherein the tether is removably attached to the magnetic clip and the magnetic disk.

4. The cord management system of claim 1, wherein the magnetic disk is integrated with a wearable garment.

5. The cord management system of claim 4, wherein the magnetic disk is provided in pockets of the wearable garment.

6. The cord management system of claim 4, wherein the magnetic disk is a patch adapted to be applied to a patch location on the wearable garment.

7. The cord management system of claim 1, further comprising a wearable accessory adapted to hold the magnetic clip.

8. The cord management system of claim 7, wherein the wearable accessory is a necklace.

9. The cord management system of claim 1, wherein the magnetic clip supports an accessory.

10. The cord management system of claim 9, wherein the accessory includes an integrated electronic device.

11. A cord management system comprising:
a magnetic clip;
a wire retainer disposed on a first side of the magnetic clip, the wire retainer operable to hold a wire therein;
a magnetic disk magnetically attracted to the magnetic clip; and
a tether holding the magnetic clip on a first end thereof and holding the magnetic disk on a second, opposite end thereof, the tether being made of a flexible material.

12. The cord management system of claim 11, wherein the tether is removably attached to the magnetic clip and the magnetic disk.

13. The cord management system of claim 11, wherein the tether is permanently attached to the magnetic clip and the magnetic disk.
